(19) United States
(12) Patent Application Publication
(10) Pub. No.: US 2024/0201668 A1
(43) Pub. Date: Jun. 20, 2024

(54) SYSTEM AND METHOD WITH SEQUENCE MODELING OF SENSOR DATA FOR MANUFACTURING

(71) Applicant: Robert Bosch GmbH, Stuttgart (DE)

(72) Inventors: Filipe Condessa, Pittsburgh, PA (US); Devin Willmott, Pittsburgh, PA (US); Ivan Batalov, Pittsburgh, PA (US); Joao Semedo, Pittsburgh, PA (US); Zhichun Huang, Pittsburgh, PA (US); Wan-Yi Lin, Wexford, PA (US); Bahare Azari, San Jose, CA (US)

(21) Appl. No.: 18/067,410

(22) Filed: Dec. 16, 2022

(51) Int. Cl. G05B 19/418

(52) U.S. Cl. CPC G05B 19/4184; G05B 19/4183

(57) ABSTRACT

A computer-implemented system and method include establishing a station sequence that a given part traverses. A history embedding sequence is generated and comprises (a) history measurement embeddings based on history measurement data, the history measurement data relating to attributes of at least one other part that traversed the plurality of stations before the given part, (b) history part identifier embeddings based at least one history part identifiers of at least one other part, and (c) history station identifier embeddings based on the at least one history station identifier corresponding to the history measurement data. An input embedding sequence is generated and comprises (a) measurement embeddings based on observed measurement data, the observed measurement data relating to attributes of the given part at each station of a station subsequence of the station sequence, (b) part identifier embeddings based on a part identifier of the given part, and (c) station identifier embeddings based on station identifiers corresponding to the observed measurement data. An encoding network generates intermediate history features based on the history embedding sequence. A decoding network generates predicted measurement data based on the intermediate history features and the input embedding sequence. The predicted measurement data includes next measurement data of the given part at a next station, where the next station follows the station subsequence in the station sequence.

### TECHNICAL FIELD

This disclosure relates generally to predictive maintenance, and more particularly to machine learning systems with sequence modeling for predictive monitoring of industrial machines and/or product parts.

### BACKGROUND

An industrial manufacturing process may include a number of workstations with industrial machines, which are employed in a particular order to produce a particular product. For example, such industrial manufacturing processes are typically used in assembly plants. Unfortunately, there may be instances in which one or more industrial machines may fail to perform at satisfactory levels or may fail completely. Such machine failures may result in low grade products, incomplete products, and/or disruptions in the industrial manufacturing process, as well as major losses in resources, time, etc.

### SUMMARY

The following is a summary of certain embodiments described in detail below. The described aspects are presented merely to provide the reader with a brief summary of these certain embodiments and the description of these aspects is not intended to limit the scope of this disclosure. Indeed, this disclosure may encompass a variety of aspects that may not be explicitly set forth below.

According to at least one aspect, a computer-implemented includes establishing a station sequence, which includes a plurality of stations that a given part traverses. The method includes generating a first set of embeddings. The first set of embeddings include (a) history measurement embeddings based on history measurement data, the history measurement data relating to attributes of one or more other parts that traversed the plurality of stations before the given part, (b) history part identifier embeddings based on one or more history part identifiers of the one or more other parts, and (c) history station identifier embeddings based on history station identifiers corresponding to the history measurement data. The method includes generating a second set of embeddings. The second set of embeddings include (a) measurement embeddings based on observed measurement data, the observed measurement data relating to attributes of the given part as obtained by one or more sensors at each station of a station subsequence of the station sequence, (b) part identifier embeddings based on a part identifier of the given part, and (c) station identifier embeddings based on station identifiers that corresponding to the observed measurement data. The method includes generating a history embedding sequence by concatenating the first set of embeddings. The method includes generating an input embedding sequence by concatenating the second set of embeddings. The method includes generating, via an encoding network, intermediate history features based on the history embedding sequence. The method includes generating, via a decoding network, predicted measurement data based on the intermediate history features and the input embedding sequence. The predicted measurement data includes next measurement data of the given part at a next station of the station sequence.

According to at least one aspect, a system includes a processor and a memory. The memory is in data communication with the processor. The memory has computer readable data including instructions stored thereon that, when executed by the processor, cause the processor to perform a method. The method includes establishing a station sequence, which includes a plurality of stations that a given part traverses. The method includes generating a first set of embeddings. The first set of embeddings include (a) history measurement embeddings based on history measurement data, the history measurement data relating to attributes of one or more other parts that traversed the plurality of stations before the given part, (b) history part identifier embeddings based on one or more history part identifiers of the one or more other parts, and (c) history station identifier embeddings based on history station identifiers corresponding to the history measurement data. The method includes generating a second set of embeddings. The second set of embeddings include (a) measurement embeddings based on observed measurement data, the observed measurement data relating to attributes of the given part as obtained by one or more sensors at each station of a station subsequence of the station sequence, (b) part identifier embeddings based on a part identifier of the given part, and (c) station identifier embeddings based on station identifiers that corresponding to the observed measurement data. The method includes generating a history embedding sequence by concatenating the first set of embeddings. The method includes generating an input embedding sequence by concatenating the second set of embeddings. The method includes generating, via an encoding network, intermediate history features based on the history embedding sequence. The method includes generating, via a decoding network, predicted measurement data based on the intermediate history features and the input embedding sequence. The predicted measurement data includes next measurement data of the given part at a next station of the station sequence.

According to at least one aspect, a non-transitory computer readable medium has computer readable data including instructions stored thereon that, when executed by a processor, cause the processor to perform a method. The method includes establishing a station sequence, which includes a plurality of stations that a given part traverses. The method includes generating a first set of embeddings. The first set of embeddings include (a) history measurement embeddings based on history measurement data, the history measurement data relating to attributes of one or more other parts that traversed the plurality of stations before the given part, (b) history part identifier embeddings based on one or more history part identifiers of the one or more other parts, and (c) history station identifier embeddings based on history station identifiers corresponding to the history measurement data. The method includes generating a second set of embeddings. The second set of embeddings include (a) measurement embeddings based on observed measurement data, the observed measurement data relating to attributes of the given part as obtained by one or more sensors at each station of a station subsequence of the station sequence, (b) part identifier embeddings based on a part identifier of the given part, and (c) station identifier embeddings based on station identifiers that corresponding to the observed measurement data. The method includes generating a history embedding sequence by concatenating the first set of embeddings. The method includes generating an input embedding sequence by concatenating the second set of embeddings. The method includes generating, via an encoding network, intermediate history features based on the history embedding sequence. The method includes generating, via a decoding network, predicted measurement data based on the intermediate history features and the input embedding sequence. The predicted measurement data includes next measurement data of the given part at a next station of the station sequence.

These and other features, aspects, and advantages of the present invention are discussed in the following detailed description in accordance with the accompanying drawings throughout which like characters represent similar or like parts.

### BRIEF DESCRIPTION OF THE DRAWINGS

FIG. 1 is diagram of an example of a system for predictive measurement monitoring according to an example embodiment of this disclosure.

FIG. 2 is diagram of a non-limiting example of an application of the system of FIG. 1 according to an example embodiment of this disclosure.

FIG. 3 is diagram of an example of a machine learning system of FIG. 1 according to an example embodiment of this disclosure.

### DETAILED DESCRIPTION

The embodiments described herein, which have been shown and described by way of example, and many of their advantages will be understood by the foregoing description, and it will be apparent that various changes can be made in the form, construction, and arrangement of the components without departing from the disclosed subject matter or without sacrificing one or more of its advantages. Indeed, the described forms of these embodiments are merely explanatory. These embodiments are susceptible to various modifications and alternative forms, and the following claims are intended to encompass and include such changes and not be limited to the particular forms disclosed, but rather to cover all modifications, equivalents, and alternatives falling with the spirit and scope of this disclosure.

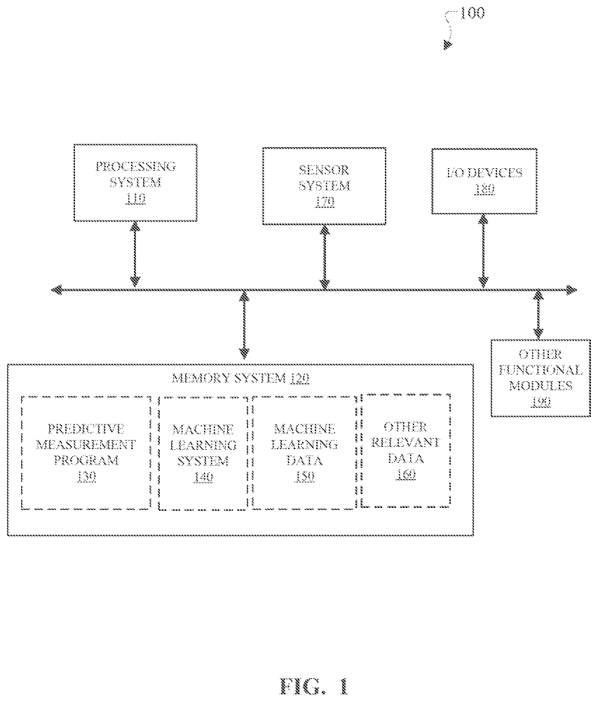

FIG. 1 is a diagram of a non-limiting example of a system 100, which learns the dynamics of manufacturing time series. In addition, the system 100 is configured to predict future measurements of a particular part at a given station. The system 100 includes at least a processing system 110 with at least one processing device. For example, the processing system 110 includes at least an electronic processor, a central processing unit (CPU), a graphics processing unit (GPU), a microprocessor, a field-programmable gate array (FPGA), an application-specific integrated circuit (ASIC), any suitable processing technology, or any number and combination thereof. The processing system 110 is operable to provide the functionality as described herein.

The system 100 includes a memory system 120, which is operatively connected to the processing system 110. In an example embodiment, the memory system 120 includes at least one non-transitory computer readable storage medium, which is configured to store and provide access to various data to enable at least the processing system 110 to perform the operations and functionality, as disclosed herein. In an example embodiment, the memory system 120 comprises a single memory device or a plurality of memory devices. The memory system 120 can include electrical, electronic, magnetic, optical, semiconductor, electromagnetic, or any suitable storage technology that is operable with the system 100. For instance, in an example embodiment, the memory system 120 includes random access memory (RAM), read only memory (ROM), flash memory, a disk drive, a memory card, an optical storage device, a magnetic storage device, a memory module, any suitable type of memory device, or any number and combination thereof. With respect to the processing system 110 and/or other components of the system 100, the memory system 120 is local, remote, or a combination thereof (e.g., partly local and partly remote). For example, the memory system 120 can include at least a cloud-based storage system (e.g. cloud-based database system), which is remote from the processing system 110 and/or other components of the system 100.

The memory system 120 includes at least a predictive measurement program 130, a machine learning system 140, machine learning data 150, and other relevant data 160, which are stored thereon. The predictive measurement program 130 includes computer readable data with instructions, which, when executed by the processing system 110, is configured to train and/or employ the machine learning system 140 to learn to generate future measurement data, which also may be referred to as predicted measurement data. The computer readable data can include instructions, code, routines, various related data, any software technology, or any number and combination thereof. In an example embodiment, the machine learning system 140 includes a transformer model. Also, the machine learning data 150 includes various data relating to the machine learning system 140. The machine learning data 150 includes various data associated with training and/or employing the machine learning system 140. For instance, the machine learning data 150 may include training data, various embedding data, various parameter data, various loss data, etc. Meanwhile, the other relevant data 160 provides various data (e.g. operating system, etc.), which enables the system 100 to perform the functions as discussed herein.

The system 100 is configured to include one or more sensor systems 170. The sensor system 170 includes one or more sensors. For example, the sensor system 170 may include an image sensor, a camera, a radar sensor, a light detection and ranging (LIDAR) sensor, a structured light sensor, a thermal sensor, a depth sensor, an ultrasonic sensor, an infrared sensor, a motion sensor, an audio sensor (e.g., microphone), a weight sensor, a pressure sensor, any applicable sensor, or any number and combination thereof. The sensor system 170 is operable to communicate with one or more other components (e.g., processing system 110 and memory system 120) of the system 100. For example, upon receiving sensor data from a sensor system 170, the sensor system 170 and/or the processing system 110 may generate sensor-fusion data. If needed, the processing system 110 may perform one or more data preparation operations to the sensor data and/or sensor-fusion data to provide input data (e.g., observed measurement data) of suitable form (e.g., numerical data) for the machine learning system 140. The sensor system 170 is local, remote, or a combination thereof (e.g., partly local and partly remote). The sensor system 170 may include one or more sensors at one or more of the stations of a given station sequence that a given part traverses. Additionally or alternatively, there may be one or more sensor systems 170 at each station of the station sequence that a given part traverses. Upon receiving the sensor data, the processing system 110 is configured to process this sensor data in connection with the predictive measurement program 130, the machine learning system 140, the machine learning data 150, the other relevant data 160, or any number and combination thereof.

In addition, the system 100 may include at least one other system component. For example, as shown in FIG. 1, the memory system 120 is also configured to store other relevant data 160, which relates to operation of the system 100 in relation to one or more system components (e.g., sensor system 170, I/O devices 180, and other functional modules 190). In addition, the system 100 is configured to include one or more I/O devices 180 (e.g., display device, keyboard device, speaker device, etc.), which relate to the system 100. Also, the system 100 includes other functional modules 190, such as any appropriate hardware, software, or combination thereof that assist with or contribute to the functioning of the system 100. For example, the other functional modules 190 include communication technology (e.g. wired communication technology, wireless communication technology, or a combination thereof) that enables system components of the system 100 to communicate with each other as described herein.

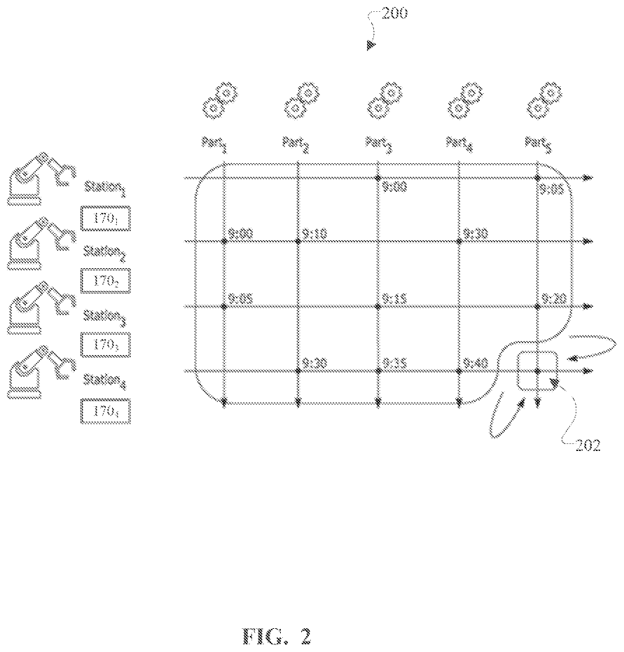

FIG. 2 is a non-limiting example of a graphical representation 200 of a time-ordered, directed graph model. More specifically, in this graphical representation 200, each black circle denotes multimodal measurement data or records associated with a particular part in relation to a particular station. Each black circle is also provided with a time stamp, indicating a time in which a particular part is measured by sensor system 170ᵢ at a particular station, where i represents an integer value greater than one. For instance, this graphical representation 200 captures the following measurement events: part1 is measured by one or more sensors of sensor system 170₂ at station2 at 9:00, and measured by one or more sensors of sensor system 170₃ at station3 at 9:05; part2 is measured by one or more sensors of sensor system 170₂ at station2 at 9:10, and measured by one or more sensors of sensor system 170₄ at station4 at 9:30; part3 is measured by one or more sensors of sensor system 170₁ at station1 at 9:00, measured by one or more sensors of sensor system 170₃ at station3 at 9:15, and measured by one or more sensors of sensor system 170₄ at station4 at 9:35; part4 is measured by one or more sensors of sensor system 170₂ at station2 at 9:30 and measured by one or more sensors of sensor system 170₄ at station4 at 9:40; part5 is measured by one or more sensors of sensor system 170₁ at station1 at 9:05 and measured by one or more sensors of sensor system 170₃ at station3 at 9:20. In this regard, part5 has passed through the station subsequence of station1 and station3 and further needs to pass through station4 to complete the established station sequence of station1, station3, and station4.

In FIG. 2, the graphical representation 200 illustrates non-limiting examples of measurement data collection at an assembly plant. Other non-limiting examples may include more or less than five parts and/or more or less than four stations. The arrows in the graph show the time progression for each part (going top to bottom), and for each station (going left to right). In addition, the graphical representation 200 includes an irregular shape around previous measurement events to indicate known information and/or observed measurements, which have been captured by the system 100 prior to this given instance. The graphical representation 200 also includes a rectangular shape around the black circle at the intersection of part5 and station4 to denote an example of missing information or unavailable information at this given instance.

As shown in FIG. 2, the manufacturing process associated with part5 includes a station sequence of station1, station3, and station4. More specifically, the system 100 is configured to provide a relatively accurate prediction or estimation of the target data 202 (e.g., measurement data or record) without having to directly perform actual measurements of part5 at station4 at that given instance. Also, the system 100 is configured to generate this prediction or estimation of the target data 202 when the part5 is at station3 (i.e., before part5 even arrives at station4). The system 100 is configured to predict the measurements or records for part5 with respect to station4 given the past representations. For example, the machine learning system 140 is configured to generate prediction data (one or more measurement data) for part5 at station4 based on observed measurement data of part5 taken at station1, observed measurement data of part5 taken at station3, history measurement data of part3 at station1, history measurement data of part3 at station3, history measurement data of part1 at station3, history measurement data of part4 at station4, history measurement of part3 at station4, and history measurement of part2 at station4 in the case of M prior steps, where in this case M=4. This is advantageous as part5 may be prevented from advancing to station4 if the system 100 generates predicted measurement data, which is deemed to be at an unsatisfactory level. To generate this predicted measurement data, the system 100 includes the machine learning system 140, as discussed below.

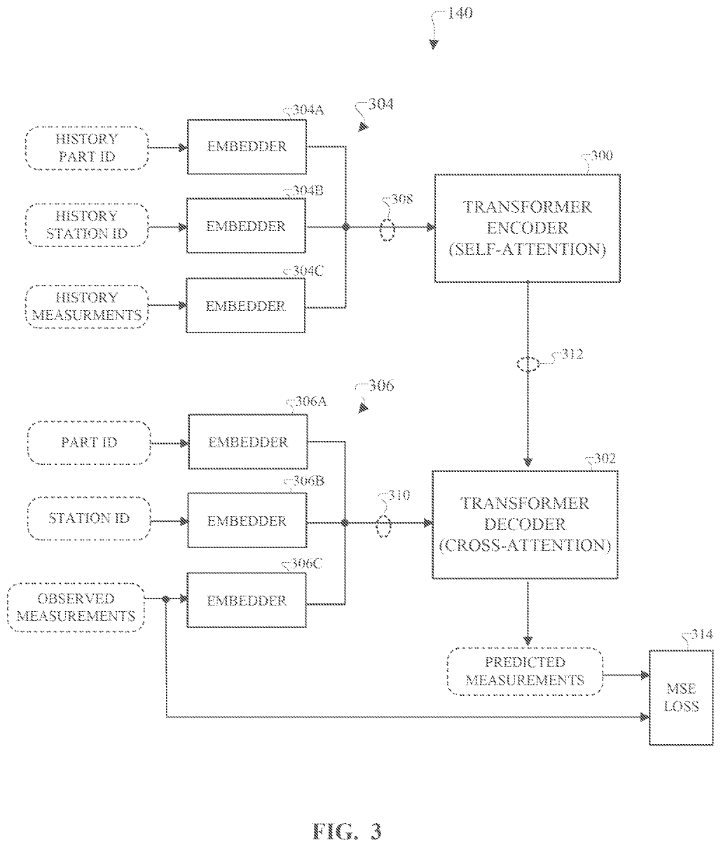

FIG. 3 is diagram of an example of a machine learning system 140 during training according to an example embodiment. The machine learning system 140 comprises a neural network model, which is configured to predict a future measurement for a particular part at a given station. The future measurement may also be referred to as the predicted measurement. To generate the predicted measurement for a particular part at a given station, the machine learning system 140 uses the part's measurements at previous stations as well as the history of measurements performed at that given station. More specifically, in the example shown in FIG. 3, the machine learning system 140 includes at least a transformer model and a plurality of embedders. The transformer model includes an encoder 300 and a decoder 302. The plurality of embedders includes a first set of embedders 304, which are connected to the encoder, and a second set of embedders 306, which are connected to the decoder 302. With this configuration, as shown in FIG. 3, the transformer model learns measurement representation and the relationship amongst them for a particular part processed at a set of given stations using a self-attention mechanism. Furthermore, a cross-attention mechanism is used to incorporate information from the previous measurements in each station.

For the machine learning system 140, the system 100 arranges various data as a collection of part-view trajectories/paths [symbol] . Each path τₖ is a sequence of sparse multimodal structural measurements collected at a particular station over time for a specific part alongside the history measurements at that station, i.e., τ=(x₁, h₁), . . . , (xₜ_{ₖ}, hₜ_{ₖ}). The sparse part measurement x∈ [symbol] ^{D} is a vector that can only be evaluated at specific indices corresponding to the type of measurements collected at that particular station. The sparse history measurement h∈ [symbol] ^{D×M} is the succession of M previous measurements at each station. D is the number of all the possible measurements that can be collected at all the stations.

The measurements and/or the measurement data may be a binary value, a strength value, a time series value (e.g., a measurement of the response to pressure), floating precision number, number string, integer, Boolean, aggregation of statistics, or the like which provides attribute information of the part. The measurement data may be based on raw sensor data from one or more sensors at a station, sensor-fusion data from sensors at a station, or any number and combination thereof. The raw sensor data may include image data, video data, audio data, text data, alphanumeric data, or any number and combination thereof. The processing system 110 is configured to perform one or more data preparation operations on the raw sensor data to provide measurement data as input to the machine learning system 140.

The machine learning system 140 is to learn a probability distribution of future measurements given past measurements to be then used for prediction/estimation of the future measurement values. Assuming first-order Markovian dependency among part-view measurements, the joint probability of measurements, given history measurements at each station, ((x₁, h₁), . . . , (xₜ, hₜ), . . . , (xₜ_{ₖ}, hₜ_{ₖ})) can be expressed as a factorized distribution over part (x) and history (h) measurements, as expressed in equation 1. In this regard, the machine learning system 140 extends the first-order assumption and deploys a higher-order temporal dependency using a transformer model.

$$p ( x \vert h ) = {\prod }_{t = 1}^{{t}_{k}} p ( {x}_{t} \vert {h}_{t} , {x}_{t - 1} ) \qquad [ 1 ]$$

The machine learning system 140 involves multiple inputs, which include input data relating to a set of part-view sequences. A part-view sequence is representative of a part traversing along a trajectory of stations [symbol] ∈{1, . . . , K}. The input data includes a list of D dimensional measurements [x₁, . . . , xₜ_{ₖ}] for each sequence k∈ [symbol] of length tₖ, x∈ [symbol] ^{D}. The input data includes a list of part ids [p₁, . . . , pₜ_{ₖ}] associated to each sequence k∈ [symbol] . The input data includes a list of station ids [s₁, . . . , sₜ_{ₖ}] associated with each sequence k∈ [symbol] . The input data includes history information for the past M steps for each station in the sequence. This history information includes the past M history measurements [h₁^{(1:M)}, . . . , hₜ_{ₖ}^{(1:M)}] for each station in sequence k∈ [symbol] the corresponding history part ids [p₁^{(1:M)}, . . . , pₜ_{ₖ}^{(1:M)}], and the corresponding history station ids [s₁^{(1:M)}, . . . , sₜ_{ₖ}^{(1:M)}].

The first set of embedders 304 include one or more embedders. The first set of embedders 304 are configured to generate corresponding embeddings, which are concatenated and provided as input for the encoder. For example, in FIG. 3, the first set of embedders 304 include a first embedder 304A, a second embedder 304B, and a third embedder 304C, which receive the history information and may be arranged in any order. Upon receiving history part identifiers [p₁^{(1:M)}, . . . , pₜ_{ₖ}^{(1:M)}], the first embedder 304A generates history part identifier embeddings based on the history part identifiers [p₁^{(1:M)}, . . . , pₜ_{ₖ}^{(1:M)}]. Upon receiving history station identifiers [s₁^{(1:M)}, . . . , sₜ_{ₖ}^{(1:M)}], the second embedder 304B generates one or more history station identifier embeddings based on the history station identifiers [s₁^{(1:M)}, . . . , sₜ_{ₖ}^{(1:M)}]. Upon receiving history measurements [h₁^{(1:M)}, . . . , sₜ_{ₖ}^{(1:M)}], the third embedder 304C generates history measurement embeddings based on the history measurements [h₁^{(1:M)}, . . . , hₜ_{ₖ}^{(1:M)}]. After generating each of the aforementioned embeddings, the system 100 generates a history embedding sequence 308 by concatenating the history measurement embeddings, the history part identifier embeddings, and the history station identifier embeddings. The history embedding sequence 308 is provided as input for the encoder 300.

The second set of embedders 306 include one or more embedders. The second set of embedders 306 are configured to generate corresponding embeddings, which are concatenated and provided as input for the encoder 300. For example, in FIG. 3, the second set of embedders 306 include a first embedder 306A, a second embedder 306B, and a third embedder 306C, which receive observed information and may be arranged in any order. Upon receiving part identifiers [p₁, . . . , pₜ_{ₖ}], the first embedder 306A generates part identifier embeddings based on the part identifiers [p₁, . . . , pₜ_{ₖ}]. Upon receiving station identifiers [s₁, . . . , sₜ_{ₖ}], the second embedder 306B generates one or more station identifier embeddings based on the station identifiers [s₁, . . . , sₜ_{ₖ}]. Upon receiving measurements [x₁, . . . , xₜ_{ₖ}], the third embedder 306C generates measurement embeddings based on the measurements [x₁, . . . , xₜ_{ₖ}]. After generating each of the aforementioned embeddings, the system 100 generates an input embedding sequence 310 by concatenating the measurement embeddings, the part identifier embeddings, and the station identifier embeddings. The input embedding sequence 310 is provided as input data for the decoder 302.

The encoder 300 comprises an encoding network, which is configured to receive the history embedding sequence 308 as input data. Upon receiving the history embedding sequence 308 as input, the encoder 300 combines the history embedding sequence 308 with positional embedding. The positional embedding allows the transformer model to understand the ordering and positional dependency of the history information (or the first set of input vectors that include the part ID, the station ID, and the observed measurement data). The encoder 300 generates intermediate embedding data and passes this intermediate embedding data through multiple layers of self-attention networks including self-attention layers, dropout layers, and linear layers. A self-attention layer is a differentiable neural network layer, which performs a soft key-value search on the history embedding sequence 308 to construct an output sequence of the same dimension as a weighted summation of values, where each is weighted by the similarity of the corresponding query and key. For example, given the input embedding sequence 308, separate projections of input into three matrices query (Q), key (K), and value (V) are created. This output sequence of the self-attention layer is then a weighted summation of values, where weights are soft similarity search between rows and columns of the query and key matrices, respectively, as Y=softmax(QK^{T})V. Also, self-attention involves adding the output to the residual connection and normalizing. In this regard, the encoder 300 is configured to generate intermediate history features 312 based on the history embedding sequence 308. The encoder 300 is connected to the decoder 302. The intermediate history features 312 are sent from the encoder 300 to the decoder 302.

The decoder 302 comprises a decoding network, which is configured to receive the intermediate history features 312 and the input embedding sequence 310 as input data. Upon receiving the input embedding sequence 310, the decoder 302 combines the input embedding sequence 310 with positional embedding. The positional embedding allows the transformer model to understand the ordering and positional dependency of the observed information (or the second set of input vectors that include the part ID, the station ID, and the observed measurement data). The decoder 302 generates predicted embedding data and passes this predicted embedding data through multiple layers of cross-attention networks alongside the intermediate history features 312. In this regard, cross-attention refers to an attention mechanism that integrates two different embedding sequences of the same dimension. These two embedding sequences can also be of different modalities, e.g., image and text. Given two embedding sequences X₁ (e.g., intermediate history features 312) and X₂ (e.g., input embedding sequence 310), the key and the value are calculated from X₁ (e.g., intermediate history features 312) using different projection matrices, while the query is calculated from X₂ (e.g., input embedding sequence 310). The output sequence is then computed following similar steps to the self-attention mechanism, where the initial output is expressed in equation 2.

$$Y = softmax ( ( {W}_{Q} {X}_{2} ) {( {W}_{K} {X}_{1} )}^{⊤} ) ( {W}_{V} {X}_{1} ) \qquad [ 2 ]$$

The decoder 302 also includes dropout layers and linear layers. In the decoding network, the keys and values are computed based on the intermediate history features 312 while the queries are computed based on the input embedding sequence 310. The decoder 302 is configured to generate a shifted version of the decoder's input (e.g., the observed input vectors that include the observed measurements, the part identifiers, and the station identifiers) by one that mimics the next time point prediction. The decoder 302 is configured to generate at least output data, which includes at least one predicted measurement for a particular part at a given station (e.g., the next station of a station sequence that the particular part traverses). The predicted measurement is a vector, which includes one or measurement data.

As discussed above, in summary, the machine learning system 140 is configured for part-view sequences and includes at least (i) a transformer encoder 300 and (ii) a transformer decoder 302. The encoder 300 is applied to the history embedding sequence 308 to produce intermediate history features 312. The encoder 300 uses a linear network followed by multiple layers of causal transformer blocks to apply self-attention to the history embedding sequence 308. In the decoder network, the input embedding sequence 310 and the intermediate history features 312 are combined using a cross-attention mechanism. The input embedding sequence 310 goes through a series of causal self-attention layers to produce the queries for the cross-attention layer. At the same time, the intermediate history features 312 are fed to the cross-attention layer as both keys and values. The output of the cross-attention layer goes through further processing, such as getting combined with the residual connection and passing through a fully-connected network to convert to the final output (i.e., the predicted measurement data). The causality of the decoder 302 is induced by introducing a causal mask in the cross-attention layer that hides away the future value to be predicted in the sequence. The encoder 300 and the decoder 302 are equipped with dropout layers at different levels of the network for regularization. In addition, the transformer model may further include at least one multi-head attention layer, where each key, value, and query are multiplied by an additional projection weight matrix. The resulting embedding is broken up along the feature dimension into different heads. All heads are passed through a unique attention mechanism in parallel, and the resulting outputs are concatenated back together.

Furthermore, during training, as shown in FIG. 3, the processing system 110 generates loss data based on a comparison (or distance) between ground truth data (e.g., corresponding observed measurement data) and the predicted measurement data. The loss data is generated by a loss function. More specifically, in this example, the loss function is a mean-squared error (MSE) loss function 314, or any applicable loss function that compares ground truth measurements to their corresponding predicted measurements. The processing system 110 updates parameters of the transformer model based on the loss data. Once trained, the machine learning system 140 is configured to be outputted, employed, deployed, or any number and combination thereof.

As described in this disclosure, the system 100 provides several advantages and benefits. For example, the system 100 extends the first-order assumption and deploys a higher-order temporal dependency using a transformer-based model. The transformer model learns measurement representations and the relationship amongst them for a particular part processed at a set of given stations using a self-attention mechanism. Furthermore, a cross-attention mechanism is used to incorporate information from the previous measurements of each station. The system 100 trains the transformer model to learn the dynamics of manufacturing time series. Once trained, the transformer model is configured to generate measurement predictions with respect to manufacturing time series.

Also, the system 100 models manufacturing sensor data and provides valuable insight into a manufacturing process. Also, the machine learning system 140 is a robust predictive model, which is based on sensor time series data for forecasting and which may alleviate the need for performing expensive and time-consuming measurements at a given instance. The machine learning system 140 does not make assumptions about data patterns. The machine learning system 140 may have less inductive bias associated with data and task characteristics compared to some Markov-based models.

That is, the above description is intended to be illustrative, and not restrictive, and provided in the context of a particular application and its requirements. Those skilled in the art can appreciate from the foregoing description that the present invention may be implemented in a variety of forms, and that the various embodiments may be implemented alone or in combination. Therefore, while the embodiments of the present invention have been described in connection with particular examples thereof, the general principles defined herein may be applied to other embodiments and applications without departing from the spirit and scope of the described embodiments, and the true scope of the embodiments and/or methods of the present invention are not limited to the embodiments shown and described, since various modifications will become apparent to the skilled practitioner upon a study of the drawings, specification, and following claims. Additionally or alternatively, components and functionality may be separated or combined differently than in the manner of the various described embodiments, and may be described using different terminology. These and other variations, modifications, additions, and improvements may fall within the scope of the disclosure as defined in the claims that follow.

What is claimed is:

1. A computer-implemented method for predictive measurement monitoring, the method comprising:
establishing a station sequence that includes a plurality of stations that a given part traverses;
generating a first set of embeddings, the first set of embeddings including (a) history measurement embeddings based on history measurement data, the history measurement data relating to attributes of one or more other parts that traversed the plurality of stations before the given part; (b) history part identifier embeddings based on one or more history part identifiers of the one or more other parts, and (c) history station identifier embeddings based on history station identifiers corresponding to the history measurement data;
generating a second set of embeddings, the second set of embeddings including (a) measurement embeddings based on observed measurement data, the observed measurement data relating to attributes of the given part as obtained by one or more sensors at each station of a station subsequence of the station sequence; (b) part identifier embeddings based on a part identifier of the given part, and (c) station identifier embeddings based on station identifiers that corresponding to the observed measurement data;
generating a history embedding sequence by concatenating the first set of embeddings;
generating an input embedding sequence by concatenating the second set of embeddings;
generating, via an encoding network, intermediate history features based on the history embedding sequence; and
generating, via a decoding network, predicted measurement data based on the intermediate history features and the input embedding sequence,
wherein the predicted measurement data includes next measurement data of the given part at a next station, the next station being after the station subsequence in the station sequence.

2. The computer-implemented method of claim 1, wherein:
the history measurement data is based on multimodal sensor data;
the observed measurement data is based on multimodal sensor data; and
the predicted measurement data is based on multimodal sensor data.

3. The computer-implemented method of claim 1, wherein a transformer model comprises the encoding network and the decoding network.

4. The computer-implemented method of claim 3, further comprising:
generating loss data by evaluating a loss function based on ground-truth measurement data and the predicted measurement data; and
updating parameters of the transformer model based on the loss data,
wherein the ground-truth measurement data including next observed measurement data of the given part at the next station.

5. The computer-implemented method of claim 3, further comprising:
applying a query, a key, and a value to the decoding network, wherein,
the query is computed based on the input embedding sequence,
the key is computed based on the intermediate history features, and
the value is computed based on the intermediate history features.

6. The computer-implemented method of claim 1, further comprising:
combining the history embedding sequence with positional embedding to generate intermediate embedding data; and
generating the intermediate history features by applying one or more self-attention networks to the intermediate embedding data,
wherein,
the positional embedding relates to ordering and positional dependency of the history embedding sequence, and
the one or more self-attention networks encode the intermediate embedding data to generate the intermediate history features.

7. The computer-implemented method of claim 1, further comprising:
combining the input embedding sequence with positional embedding to generate predicted embedding data; and
generating the predicted measurement data by applying one or more cross-attention networks to the predicted embedding data alongside the history features,
wherein,
the positional embedding relates to ordering and positional dependency of the input embedding sequence, and
the one or more cross-attention networks decode the predicted embedding data alongside the history features to generate the predicted measurement data.

8. A system comprising:
a processor; and
a memory in data communication with the processor, the memory having computer readable data including instructions stored thereon that, when executed by the processor, cause the processor to perform a method for predictive measurement monitoring, the method including:
establishing a station sequence that includes a plurality of stations that a given part traverses;
generating a first set of embeddings, the first set of embeddings including (a) history measurement embeddings based on history measurement data, the history measurement data relating to attributes of one or more other parts that traversed the plurality of stations before the given part; (b) history part identifier embeddings based on one or more history part identifiers of the one or more other parts, and (c) history station identifier embeddings based on history station identifiers corresponding to the history measurement data;
generating a second set of embeddings, the second set of embeddings including (a) measurement embeddings based on observed measurement data, the observed measurement data relating to attributes of the given part as obtained by one or more sensors at each station of a station subsequence of the station sequence; (b) part identifier embeddings based on a part identifier of the given part, and (c) station identifier embeddings based on station identifiers that corresponding to the observed measurement data;
generating a history embedding sequence by concatenating the first set of embeddings;
generating an input embedding sequence by concatenating the second set of embeddings;
generating, via an encoding network, intermediate history features based on the history embedding sequence; and
generating, via a decoding network, predicted measurement data based on the intermediate history features and the input embedding sequence,
wherein the predicted measurement data includes next measurement data of the given part at a next station, the next station being after the station subsequence in the station sequence.

9. The system of claim 8, wherein:
the history measurement data is based on multimodal sensor data;
the observed measurement data is based on multimodal sensor data; and
the predicted measurement data is based on multimodal sensor data.

10. The system of claim 8, wherein a transformer model comprises the encoding network and the decoding network.

11. The system of claim 10, further comprising:
generating loss data by evaluating a loss function based on ground-truth measurement data and the predicted measurement data; and
updating parameters of the transformer model based on the loss data,
wherein the ground-truth measurement data including next observed measurement data of the given part at the next station.

12. The system of claim 10, further comprising:
applying a query, a key, and a value to the decoding network,
wherein,
the query is computed based on the input embedding sequence,
the key is computed based on the intermediate history features, and
the value is computed based on the intermediate history features.

13. The system of claim 8, further comprising:
combining the history embedding sequence with positional embedding to generate intermediate embedding data; and
generating the intermediate history features by applying one or more self-attention networks to the intermediate embedding data,
wherein,
the positional embedding relates to ordering and positional dependency of the history embedding sequence, and
the one or more self-attention networks encode the intermediate embedding data to generate the intermediate history features.

14. The system of claim 8, further comprising:
combining the input embedding sequence with positional embedding to generate predicted embedding data; and
generating the predicted measurement data by applying one or more cross-attention networks to the predicted embedding data alongside the history features,
wherein,
the positional embedding relates to ordering and positional dependency of the input embedding sequence, and
the one or more cross-attention networks decode the predicted embedding data alongside the history features to generate the predicted measurement data.

15. A non-transitory computer readable medium having computer readable data including instructions stored thereon that, when executed by a processor, cause the processor to perform a method for predictive measurement monitoring, the method including:
establishing a station sequence that includes a plurality of stations that a given part traverses;
generating a first set of embeddings, the first set of embeddings including (a) history measurement embeddings based on history measurement data, the history measurement data relating to attributes of one or more other parts that traversed the plurality of stations before the given part; (b) history part identifier embeddings based on one or more history part identifiers of the one or more other parts, and (c) history station identifier embeddings based on history station identifiers corresponding to the history measurement data;
generating a second set of embeddings, the second set of embeddings including (a) measurement embeddings based on observed measurement data, the observed measurement data relating to attributes of the given part as obtained by one or more sensors at each station of a station subsequence of the station sequence; (b) part identifier embeddings based on a part identifier of the given part, and (c) station identifier embeddings based on station identifiers that corresponding to the observed measurement data;
generating a history embedding sequence by concatenating the first set of embeddings;
generating an input embedding sequence by concatenating the second set of embeddings;
generating, via an encoding network, intermediate history features based on the history embedding sequence; and
generating, via a decoding network, predicted measurement data based on the intermediate history features and the input embedding sequence,
wherein the predicted measurement data includes next measurement data of the given part at a next station, the next station being after the station subsequence in the station sequence.

16. The non-transitory computer readable medium of claim 15, wherein a transformer model comprises the encoding network and the decoding network.

17. The non-transitory computer readable medium of claim 16, further comprising:
generating loss data by evaluating a loss function based on ground-truth measurement data and the predicted measurement data; and
updating parameters of the transformer model based on the loss data,
wherein the ground-truth measurement data including next observed measurement data of the given part at the next station.

18. The non-transitory computer readable medium of claim 16, further comprising:
applying a query, a key, and a value to the decoding network,
wherein,
the query is computed based on the input embedding sequence,
the key is computed based on the intermediate history features, and
the value is computed based on the intermediate history features.

19. The non-transitory computer readable medium of claim 15, further comprising:
combining the history embedding sequence with positional embedding to generate intermediate embedding data; and
generating the intermediate history features by applying one or more self-attention networks to the intermediate embedding data,
wherein,
the positional embedding relates to ordering and positional dependency of the history embedding sequence, and
the one or more self-attention networks encode the intermediate embedding data to generate the intermediate history features.

20. The non-transitory computer readable medium of claim 16, further comprising:
combining the input embedding sequence with positional embedding to generate predicted embedding data; and
generating the predicted measurement data by applying one or more cross-attention networks to the predicted embedding data alongside the history features,
wherein,
the positional embedding relates to ordering and positional dependency of the input embedding sequence, and
the one or more cross-attention networks decode the predicted embedding data alongside the history features to generate the predicted measurement data.
